(19) United States
(12) Patent Application Publication
(10) Pub. No.: US 2008/0084786 A1
(43) Pub. Date: Apr. 10, 2008

(54) FLUID EQUILIBRATION SYSTEM

(76) Inventor: Ray Wilson Scott, Hope Hull, AL (US)

Correspondence Address: DICKINSON WRIGHT PLLC, 1901 L. STREET NW, SUITE 800, WASHINGTON, DC, 20036, US

(21) Appl. No.: 11/867,175

(22) Filed: Oct. 4, 2007

Related U.S. Application Data
(60) Provisional application No. 60/849,011, filed on Oct. 4, 2006.

(51) Int. Cl. B01F 5/10

(52) U.S. Cl. 366/151.1; 366/164.2

(57) ABSTRACT

An apparatus for use in fluid recirculation to, for example, mix oxygen-rich top water and oxygen-poor bottom water in a lake. Specifically, the recirculation apparatus has an enclosure with a wall defining an interior space and a closed end and an open end, the wall having a plurality of openings. Also included is rotating propeller assembly, a flotation device disposed within the interior space and attached to the enclosure, so that the apparatus is buoyant with the open end facing downward; and the openings are configured to be at or near the top surface of the fluid medium. The apparatus may also include a flexible anchoring system and controllers, including the use of oxygen sensors.

### CROSS REFERENCE TO RELATED APPLICATIONS

The present application claims priority to U.S. provisional application entitled FLUID EQUILIBRATION SYSTEM having Ser. No. 60/849,011 and filed Oct. 4, 2006, the contents of which are herein incorporated by reference to the extent allowed by law.

### BACKGROUND OF THE INVENTION

1. Field of the Invention

The present invention generally relates to a system and apparatus for use in distribution and equilibration of a volume of fluid, such as a lake. More specifically the present invention may be used as a fluid aeration system to increase the depth of oxygen-rich water in a lake. The invention, properly used, can increase the quantity and depth of oxygenated water significantly.

2. Related Art

In the art there is often a need to mix, re-circulate, aerate, or equilibrate large volumes of fluids. For example, it is desirable to mix large bodies of fluids, such as lakes, to maintain an even distribution of properly oxygenated water and chemicals. Large bodies of water, such as lakes, both natural and man-made, tend not to have adequate water circulation to adequately oxygenate the water below the first few feet of depth. Water in the upper strata of the lake are exposed to sunlight and plant growth. Plants release oxygen through photosynthesis, causing the upper strata of the lake to be oxygen-rich. Water below these strata, without plant life or sunlight, can be depleted of oxygen and may be generally uninhabitable for fish and other aquatic creatures. Problems can also arise when storms or other events cause the water in the lake to mix, causing the oxygen-rich upper strata of water to be mixed with the lower oxygen-depleted water. In such cases, all water in a lake may become uninhabitable, causing essentially all fish and other aquatic creatures to die.

There is thus a desire and need in the art for providing a system and apparatus to aerate the water in a body of water, such as a lake, to increase the depth and quantity of oxygen-rich water in the lake. Such a system would increase water circulation and thus aeration, thereby increasing the depth and quantity of oxygen-rich water in the lake. Although attempts have been made in the art to provide such a system, it is an object of the present invention to provide such an apparatus that is reliable and economical.

### SUMMARY OF THE INVENTION

The present invention generally relates to a system and apparatus for use in fluid recirculation, such as a lake, resulting in increased aeration of the fluid in the lake as well as an even distribution of nutrients.

In one embodiment of the present invention, the apparatus can increase the health and productivity of a lake by mixing oxygen-rich top water and oxygen-poor bottom water, while also equilibrating the chemical and temperature distribution of water throughout a lake. As a benefit of a healthy distribution of oxygen, temperature, and nutrients, the invention allows lake managers and owners to grow more and larger fish in less fluid volume. The apparatus and system can help keep new lakes healthy, rejuvenate old lakes, and greatly reduce the likelihood of environmentally caused fish kills.

One embodiment of the present invention causes the oxygen-rich water of the upper strata of a lake to be injected gradually into the lower oxygen-poor strata, replaced by oxygen-poor water that can be oxygenated through chemical reactions caused by sunlight, such as photosynthesis. Thus, the present invention causes all water in the lake to be oxygenated and thus inhabitable for fish and other aquatic creatures. The benefits of the increased quantity and depth of oxygenated water are two-fold: (1) there exists an increased volume of water that can support fish and other aquatic life, and (2) if storms or other phenomena cause the water of the lake to mix, it will not result in oxygen-depleted water and the death of fish and other aquatic creatures.

Specifically, the present invention is a fluid recirculation apparatus having an enclosure with a wall defining an interior space (such as a cylinder shape) and having a closed end and an open end, the wall having a plurality of openings, a torque generating mechanism disposed above said closed end of the enclosure (such as an electric or solar powered motor, or internal combustion engine); a driveshaft; a propeller disposed within the interior space, wherein the mechanism is connected to the propeller by the driveshaft; a flotation device disposed within the interior space and attached to the enclosure, wherein the apparatus is buoyant when suspended in a fluid medium with the open end facing downward; and the openings are configured to be at or near the top surface of the fluid medium.

Additional features of the present invention can include a control system to control speed, duration, and direction of the propeller. Oxygen sensors may be used to this.

Another additional feature of the present invention is a flexible anchor system to maintain the apparatus in a stationary position within fluid medium. Such an anchoring system can be anchor pulleys on the enclosure, anchor line, and at least two anchors, wherein one anchor rests on a bottom of the fluid medium, and one anchor is suspended within the fluid medium.

Other features of the present invention will become more apparent to persons having ordinary skill in the art to which the present invention pertains from the following description and claims.

### BRIEF DESCRIPTION OF THE DRAWINGS

The foregoing features, as well as other features, will become apparent with reference to the description and figures below, in which like numerals represent like elements, and in which:

FIG. 1 depicts a picture of a lake without the invention (labeled “BEFORE”), a cut-away drawing of the invention, and the same lake with the invention deployed (labeled “AFTER”).

FIG. 2 shows a back-view of a prototype of the invention, with the wiring harness exposed.

FIG. 3 shows a side-view of a prototype of the invention.

FIG. 4 shows a front-view of a prototype of the invention.

FIG. 5 shows a close-up view of one possible motor that could be used in the invention.

FIG. 6 shows a close-up view of the front of one possible motor that could be used in the invention.

FIG. 7 shows another close-up view of the front of one possible motor that could be used in the invention mounted to the top of the invention.

FIG. 8 shows another view of the side of one possible motor that could be used in the invention mounted to the top of the invention.

FIG. 9 shows a top view of the front of one possible motor that could be used in the invention mounted to the top of the invention.

FIG. 10 shows a diagram of the enclosure (5) with perforations (10), one possible embodiment of the flotation means (4), and the top as they would be assembled.

FIG. 11 shows a diagram demonstrating the attachment of the motor (1) to the shaft (2) and propeller (3) in one possible embodiment of the invention.

FIG. 12 shows a diagram demonstrating the flange atop the enclosure (5) as well as the perforations in one possible embodiment of the invention.

FIG. 13 shows a diagram demonstrating the attachment of the motor (1) to the shaft (2) through the gearbox (1) and propeller (3) in one possible embodiment of the invention.

### DETAILED DESCRIPTION OF THE PREFERRED EMBODIMENT

This present invention generally relates to a system and apparatus for use in distribution and equilibration of a volume of fluid, such as a lake. More specifically the present invention may be used as a fluid aeration system to increase the depth of oxygen-rich water in the lake. The invention, properly used, can increase the quantity and depth of oxygenated water significantly. The present invention may also be used to equilibrate concentrations of various materials, such as nutrients in a lake, or to unify temperature of a fluid volume.

One embodiment of the present invention generally relates to a system and apparatus for use in causing increased circulation of the water within a body of water, such as a lake, resulting in increased oxygenation of the water within the lake, and the like. It is understood that the present invention may be practiced in a variety of fluid volumes in addition to lakes. The present invention can be useful in any situation where a slow and general circulation of fluids allows the equilibration of concentrations of a variety of fluid components, such as nutrients, chemicals, temperature, and the like.

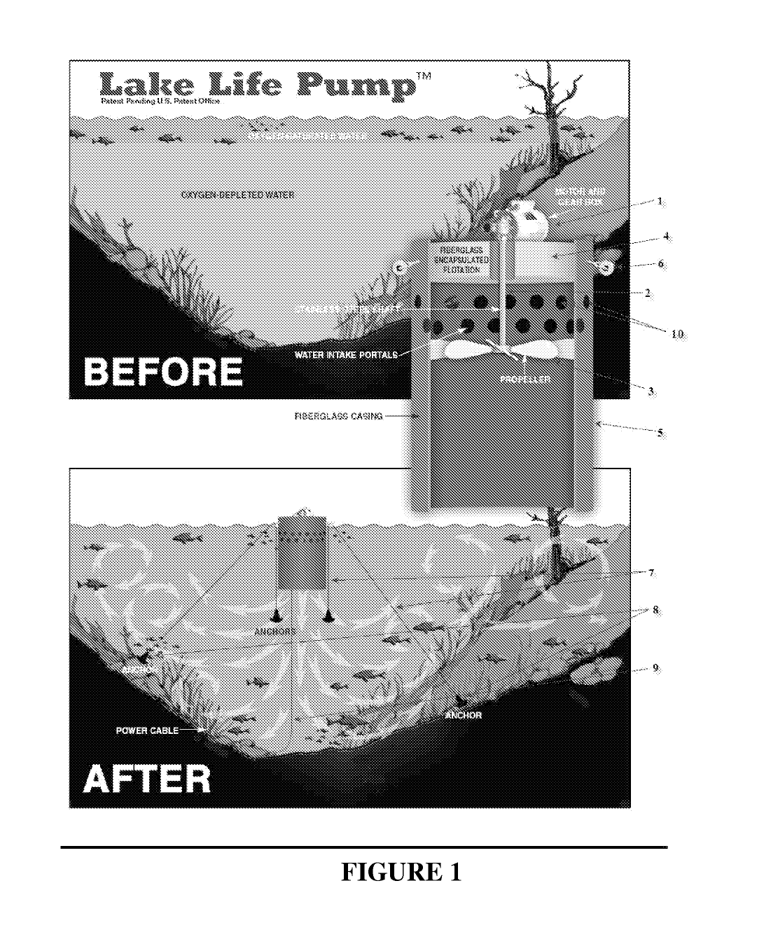

To assist in understanding the present invention, an illustration of one embodiment of the present invention is shown, as well as some terms that may generally be defined. For example, FIG. 1, illustrates one embodiment of the present invention. The basic features can include a Torque Generating Mechanism 1 to provide torque to a driveshaft such as an electric motor and gearbox, a Driveshaft 2 to connect Mechanism I to a Propeller 3, a Flotation Device 4, an Enclosure 5 defining an interior space, open at the bottom, the Propeller 3 and Driveshaft 2 being disposed therein. The Enclosure 5, as illustrated has a plurality of openings 10 such as holes, slats, and the like. The device is buoyant to approximate that Openings 10 are configured to be at a point near the surface of the fluid in which the device floats. This may be adjusted through the addition or reduction of Flotation Device 4, or the amount of weight of the anchors as described below.

Additionally, the device has components to secure Enclosure 5 in a stationary manner. As shown in FIG. 1, the securing components flexibly secure the device in a fluid medium using Anchors 8 (as shown, 2 resting on the bottom of the fluid medium, and two suspended in the fluid medium as counterweights) and Anchor line 7 connecting Anchors 8, and Enclosure 5 (through Pulley Connections 6.

Additionally, power may be provided to drive Mechanism 1 through the use of an Electrical Power Connection 9. Alternate embodiments could also power Driveshaft 2 by an internal combustion engine (not shown) or by other means known in the art. Solar Power may also be use to provide electrical power to the Mechanism 1.

In use in a lake and as illustrative in FIG. 1, Torque Mechanism 1 is configured to drive Propeller 3 such that lake water is drawn into Openings 10 and driven downward to escape at the bottom of Enclosure 5. The desired affect in this application is to force water from the upper, oxygen-saturated strata of the lake are forced down into lower oxygen-depleted strata of the lake. In this embodiment, the water from the lower, oxygen-depleted strata of the lake will be displaced upward, towards the surface of the lake, by the downward flow of oxygenated water, where it can then become oxygenated through photosynthesis by plants existing in the upper strata of the lake, as well as interaction with sunlight.

The Torque Generating Mechanism 1 turns Driveshaft 2 within the hollow Enclosure 5, thereby causing Propeller 3 to rotate within the fluid medium in which the device floats, thereby causing the fluid medium within the perforated enclosure. It is noted that Propeller 3 can rotate in either direction, depending on the desired application and still fall within the objects of the present invention.

As illustrated in FIG. 1, the apparatus may be held in place by a flexible anchoring system. As shown, at least one, and preferably more than one weight or other means can be used to secure a line to a bottom surface of the fluid volume, such as the bottom of a lake. As further shown, two anchors are used to hold a first end of two lines. A second end of said lines is fed through a pulley system attached to the enclosure as illustrated. Said second end of said lines is attached to a second weight which is sufficient to submerge the enclosure to a point where the plurality of perforations are at or near the surface of the fluid volume so that the holes are at the desired location for the application. As shown, the holes are just below the surface so that highly oxygenated surface-water may be forced down into low-oxygen areas of the lake.

Control systems can also be added to vary the intervals of use, propeller speed and direction. Controllers may also be triggered by oxygen sensors set to start and stop the system at pre-selected values.

The flotation means, as shown, is held in place above the holes with an opening to allow the driveshaft to reach the propeller.

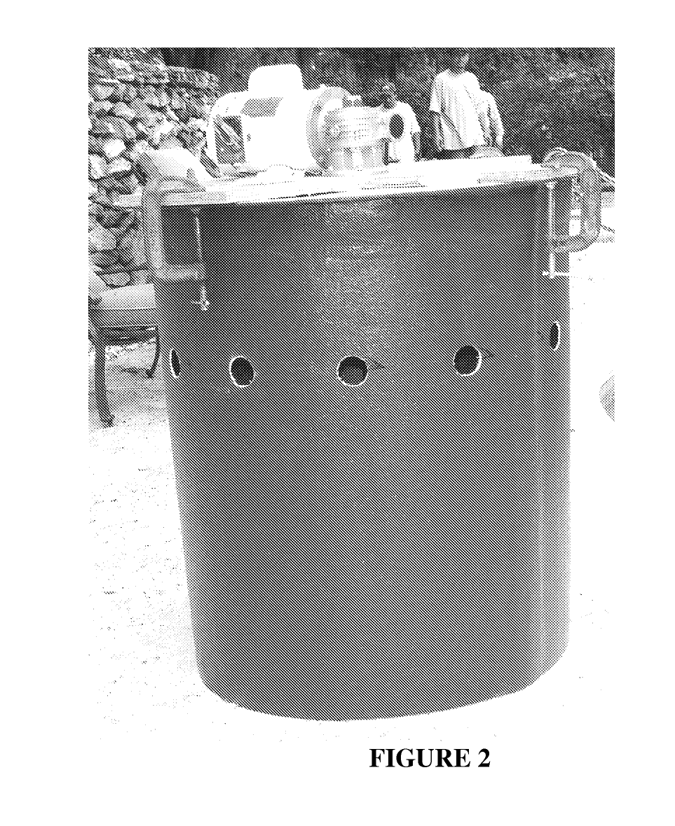

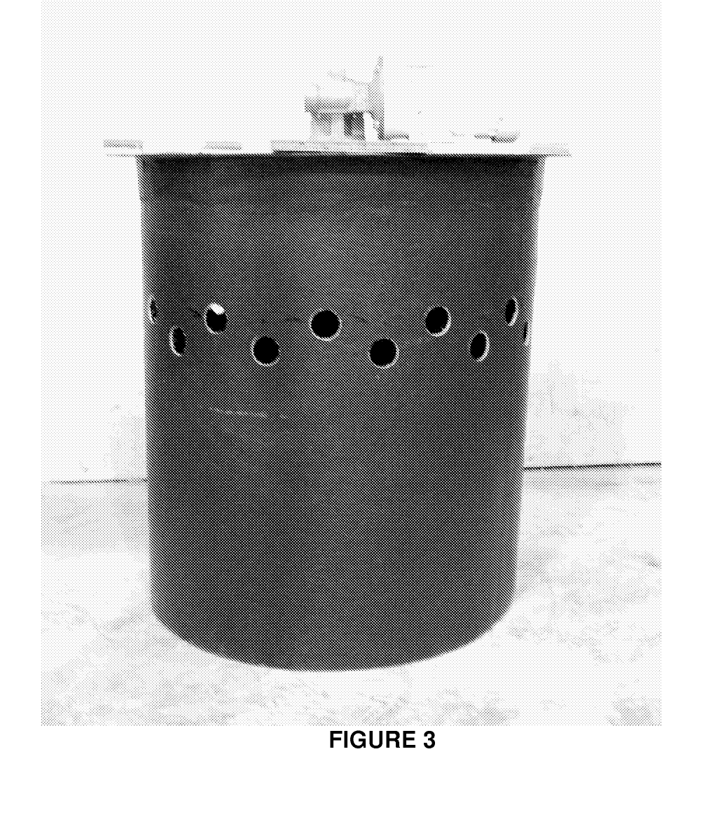

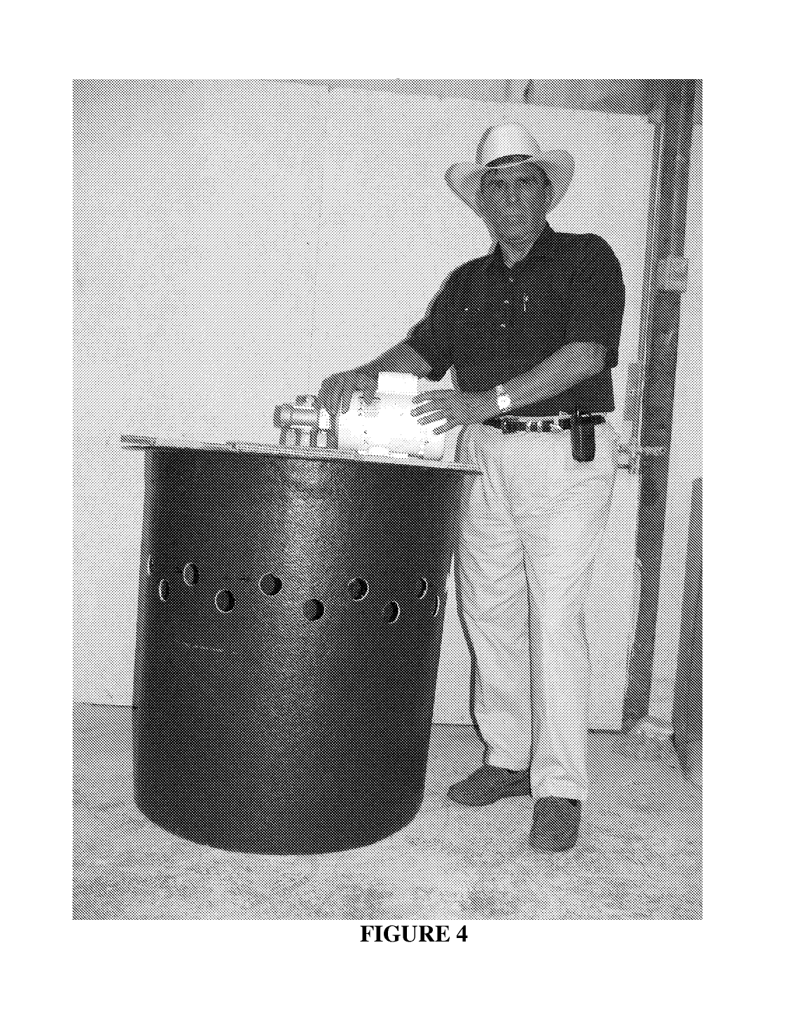

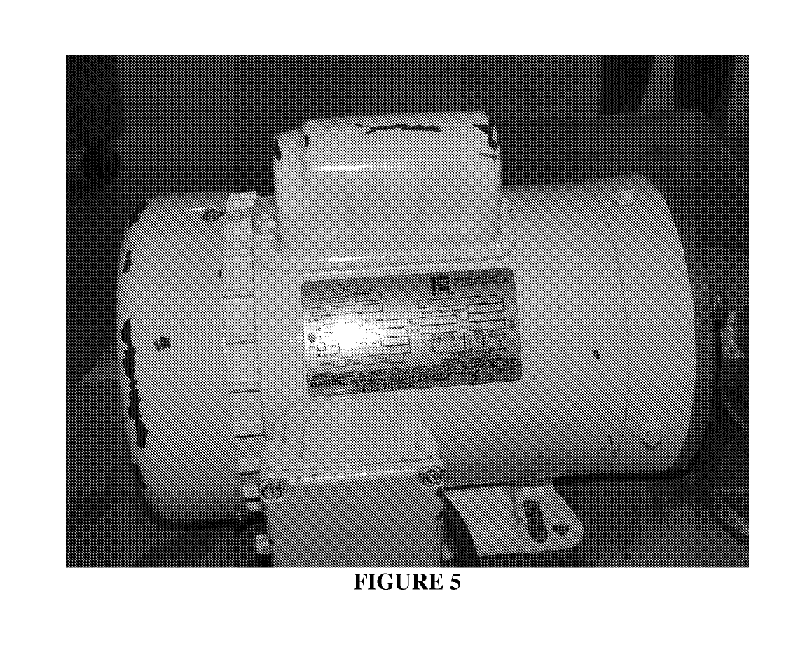

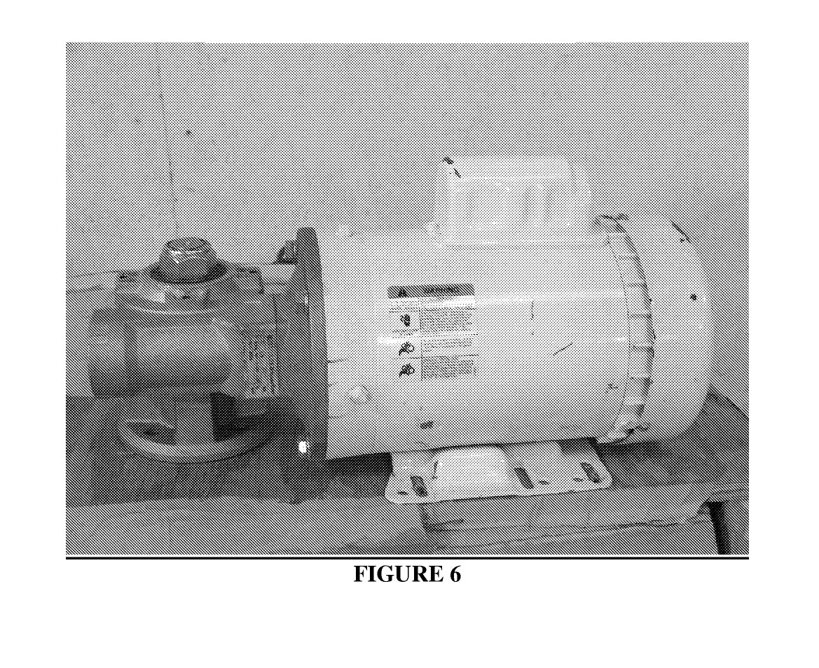

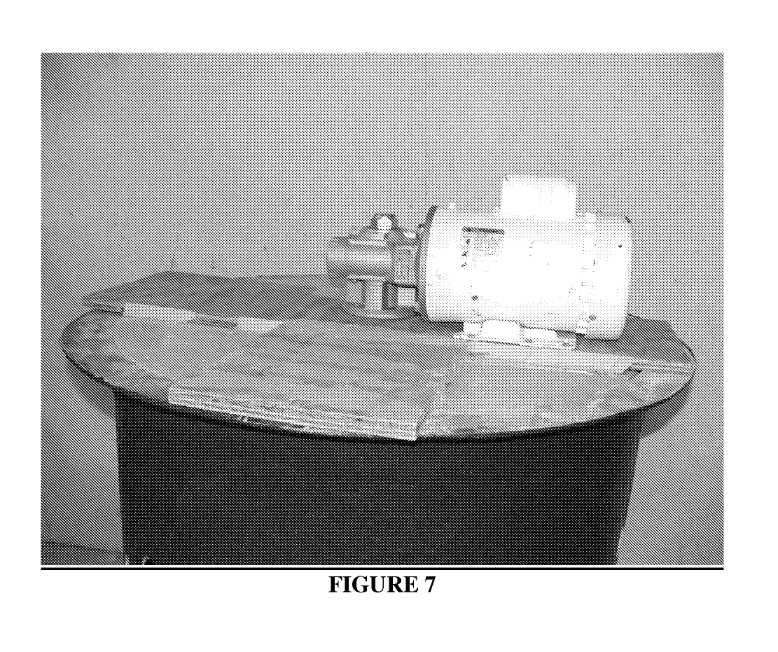

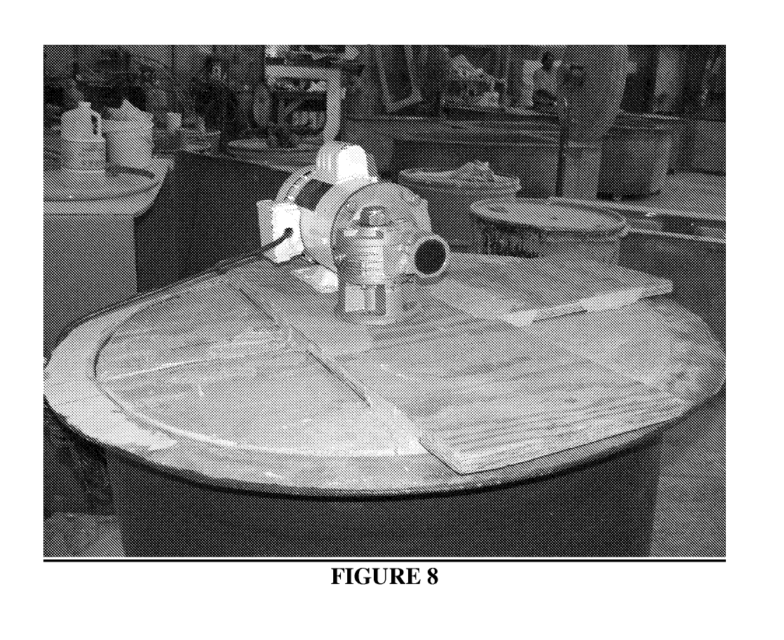

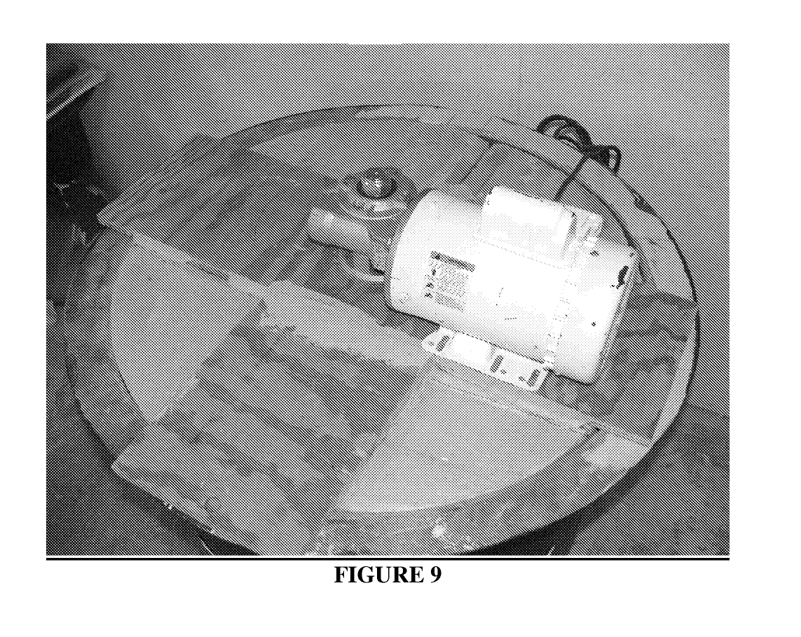

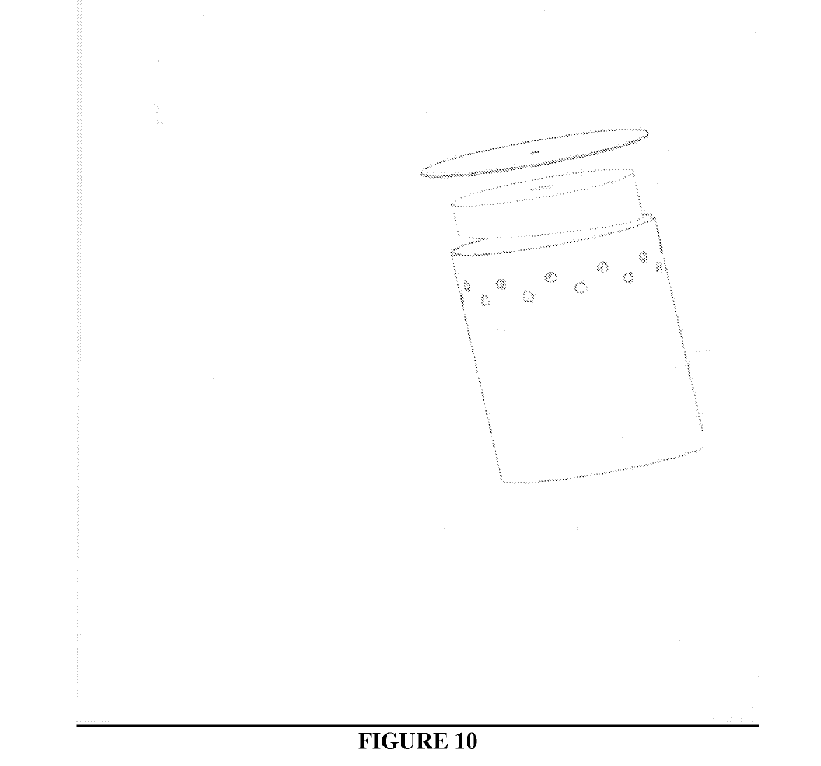

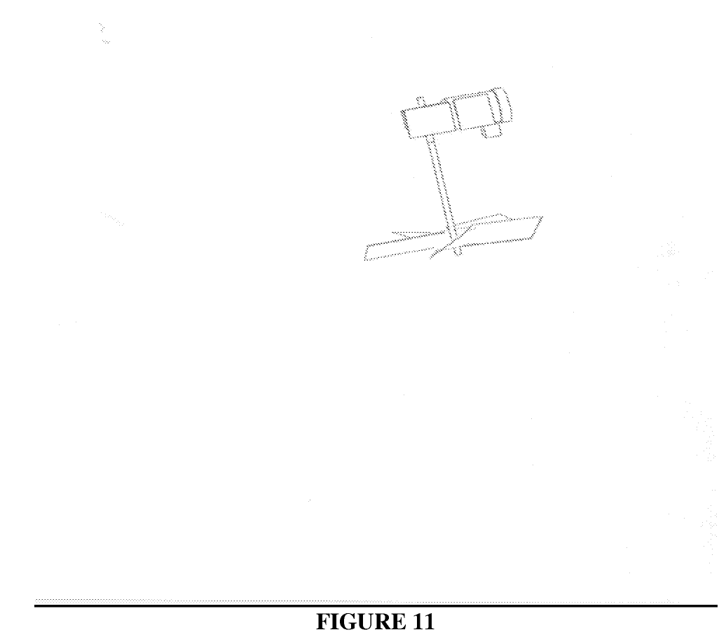

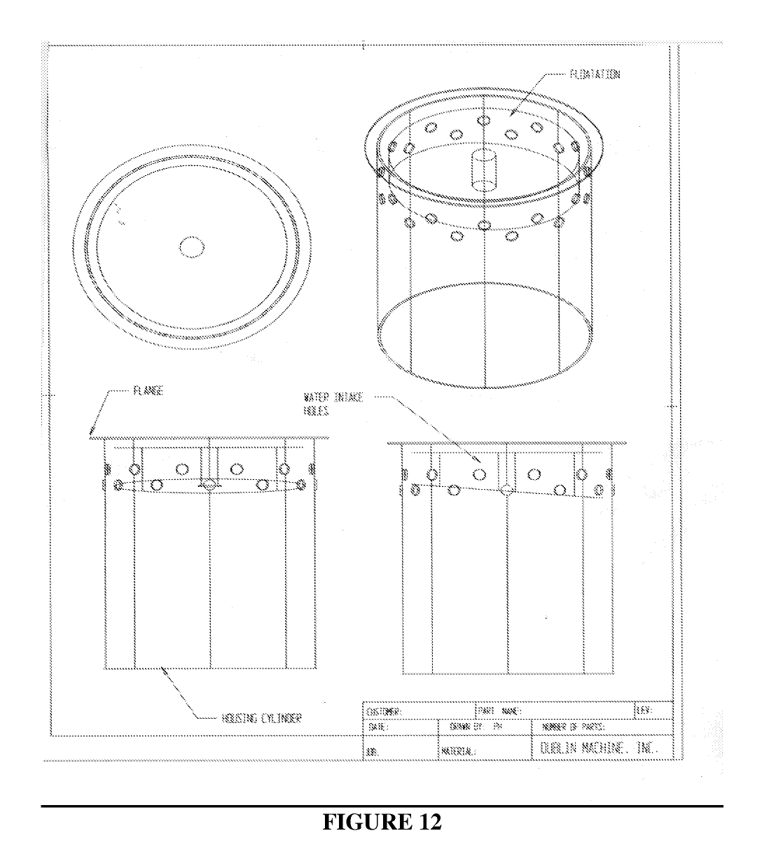

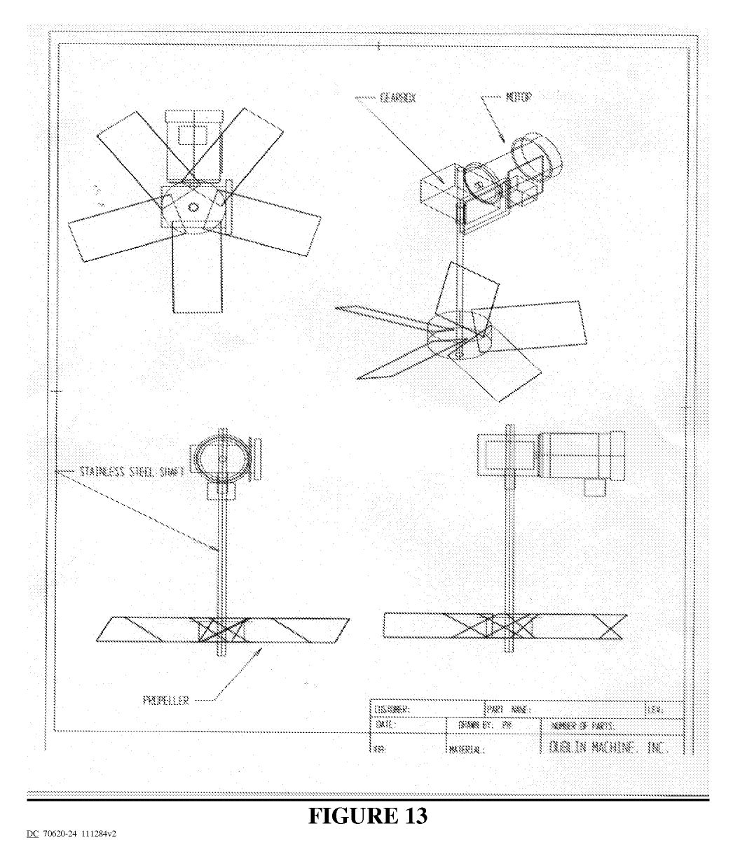

Other aspects of one embodiment of the invention are shown in FIGS. 2 through 13. FIG. 2, 3, 4 show more detail of the Enclosure 5. FIG. 5, shows a potential Torque Generating Mechanism 1, specifically an electric motor. FIG. 6 shows the addition of a gearbox to drive Driveshaft 2. FIG. 7, 8, and 9 show configurations of placement of Torque Generating Mechanism 1. FIG. 10 shows an exploded view of the Enclosure 5 top and drum as well as the Flotation Device 4 disposed therein. FIGS. 11 and 13 show an isolated view of Mechanism 1, Driveshaft 2, and Propeller 3. FIG. 12 shows an isolated view of Enclosure 5.

While the invention has been described in conjunction with specific embodiments, it is evident that many alternatives, modifications, and variations will be apparent to those skilled in the art in light of the foregoing description. Accordingly, the present invention attempts to embrace all such alternatives, modifications, and variations that fall within the spirit and scope of the specification.

What is claimed is:

1. A fluid recirculation apparatus, comprising:
an enclosure having a wall defining an interior space and having a closed end and an open end, the wall having a plurality of openings,
a torque generating mechanism disposed above said closed end of the enclosure;
a driveshaft;
a propeller disposed within the interior space, wherein the mechanism is connected to the propeller by the driveshaft;
a flotation device disposed within the interior space and attached to the enclosure, wherein the apparatus is buoyant when suspended in a fluid medium with the open end facing downward; and
the openings are configured to be at or near the top surface of the fluid medium.

2. The apparatus of claim 1, wherein the torque generating means is an electric motor.

3. The apparatus of claim 2 further comprising an electrical power line.

4. The apparatus of claim 3 further comprising a solar panel.

5. The apparatus of claim 1, wherein the torque generating means is an internal combustion engine.

6. The apparatus of claim 1, wherein the enclosure wall is in the shape of a elongated cylinder.

7. The apparatus of claim 1, further comprising a control system to control speed, duration, and direction of the propeller.

8. The apparatus of claim 7, wherein the control system uses oxygen sensors.

9. Apparatus of claim 1, further comprising an flexible anchor system to maintain the apparatus in a stationary position within fluid medium.

10. Apparatus of claim 8, wherein the flexible anchoring system is comprised of anchor pulleys on the enclosure, anchor line, and at least two anchors, wherein one anchor rests on a bottom of the fluid medium, and one anchor is suspended within the fluid medium.

11. A method of fluid recirculation comprised of the steps of:
submerging apparatus of claim 1, wherein the plurality of openings are at or near the surface of a body of fluid, and
rotating the propeller, wherein fluid is drawn into the enclosure wall openings and forced downwardly to vent out at the open end of the enclosure.

12. The method of claim 1, further comprising the step of anchoring the apparatus.

13. The method of claim 11, further comprising the step of controlling the speed, direction and duration of the propeller.

14. The method of claim 13, wherein the step of controlling the propeller comprises the step of sensing oxygen levels of the fluid medium.
